(19) United States
(12) Patent Application Publication
(10) Pub. No.: US 2002/0057286 A1
(43) Pub. Date: May 16, 2002

(54) Device independent video enhancement scripting language

(76) Inventors: Steven O. Markel, Highlands Ranch, CO (US); Philip J. Batey, Superior, CO (US)

Correspondence Address: The Law Offices of William W. Cochran LLC, Suite 230, 3555 Stanford Road, Fort Collins, CO, 80525, US

(21) Appl. No.: 10/007,437

(22) Filed: Nov. 30, 2001

Related U.S. Application Data
(60) Provisional application No. 60/227,930, filed on Aug. 25, 2000.

(51) Int. Cl. G06F 3/00; H04N 5/445; G06F 13/00; H04N 7/173; G09G 5/00

(52) U.S. Cl. 345/704; 725/109; 725/113; 725/37; 345/810

(57) ABSTRACT

A video enhancement programming language alleviates problems of multiple versions of enhancement files for various display platforms. The programming language provides elements for selection of displayable objects, object attributes, modification of object attributes, scheduling of object rendering, and transport of scheduling and object information. Links, scripts, and user input may be associated with objects. Scheduling may be referenced to program display information or may be independent of program timing information. An enhancement filed created using the programming language of the present invention may be parsed to produce platform dependent enhancement files. Some elements may include platform identifiers such that parsed files may specifically include or exclude the element. Multiple parsers, each supporting a specific platform, allow a single script file to be employed across multiple platforms. New platforms or versions of platforms may be supported through new or updated parsers.

### CROSS REFERENCE TO RELATED APPLICATIONS

This application claims the benefit of U.S. provisional application serial No. 60/227,930, filed Aug. 25, 2000, entitled “SYSTEM AND METHOD FOR WEB BASED ENHANCED INTERACTIVE TELEVISION CONTENT PAGE LAYOUT”, now U.S. patent application Ser. No. 09/935,492, filed Aug. 23, 2001 by Steve O. Markel. These applications are specifically incorporated herein by reference for all that they disclose and teach.

### BACKGROUND OF THE INVENTION

a. Field of the Invention

The present invention relates to interactive and enhanced television and, more particularly, to a method and scripting language that provide enhanced television content that may be employed across a plurality of platforms without re-editing.

b. Description of the Background

A television program may be accompanied by additional information employed to enhance the program or to provide viewer interaction. Enhancements have historically included closed captioning and multilingual support. Advances in networking, computer systems, and video production have increased the number and types of enhancements that may be provided with a program or advertisement. Enhancements may include stock updates, news stories, Internet links, weather forecasts, bulletins, statistics, trivia, and other information. For example, a football game may include icons allowing viewing of team players, player statistics, other statistics, trivia and other information such as upcoming games. Further, the advent of set-top-boxes, as may be used in cable and satellite television systems, allows enhancement information to be presented in new ways, such as screen overlays and in windows, for example.

Enhanced television content may employ a combination of HTML (hypertext markup language), JavaScript, Java and other formats common to Internet page display. An enhanced display may comprise text, icons, graphics and images placed at locations on or in proximity to the television image. To produce an enhanced display, an author may create an enhancement file identifying each displayed object (such as text, icons, graphics and images), the location where each object is displayed and the time at which the object maybe displayed. Due to numerous differences between presentation platforms, such as set top boxes, satellite receivers, computers, or interactive televisions, for example, content providers have historically been required to select a specific platform in the development of an enhancement application. In order to provide support for each additional platform, the interactive content provider must introduce potentially significant modifications to the enhancement file, resulting in ongoing maintenance of multiple enhancement files, and adding to the time and cost required producing enhanced page layouts for multiple platforms.

The creation and maintenance of multiple versions of enhancement files may also introduce unintended changes such that enhancements are not uniform across platforms. Therefore a new method and programming language for defining enhanced content that may be utilized across multiple platforms is needed.

### SUMMARY OF THE INVENTION

The present invention overcomes the disadvantages and limitations of the prior art by providing a device independent scripting language that may be employed to produce a platform independent text based script enhancement file which then may be parsed to provide output of platform specific enhancement files. The scripting language comprises commands for selection of objects, specification of object attributes, and scheduling of object rendering. Objects may comprise images, text, television images, user input areas or other elements. Object attributes may comprise color, size, font type, z order, links, position, and other aspects that define the placement, usage and appearance of objects. Scheduling of object rendering may employ a trigger that defines a time in relation to a program, or objects may be rendered independent of the program, such as flashing text, for example.

The invention therefore may comprise a television enhancement programming language comprising: an object element that provides selection of an object, a property element that specifies an attribute for the object, a trigger element that specifies a time to render the object in relation to a program, and a television element that specifies a size and position at which a program may be displayed.

The invention provides flexibility in the authoring of enhancements including usage of scripts, such as Javascript for example, to define and control enhancement presentation. A modify attributes command element allows objects to be moved, changed in color, re-sized or changed in z order, (allows objects to appear on-top or behind another element) or other attributes to be changed in a structured and efficient manner. A sync-data element provides retrieval of data from a broadcast stream, such as may be embedded in a vertical blanking interval, for example.

The enhancement file, which may employ an XML format, contains a description of enhancements including object position, attributes, triggering, action and linkage. Triggering identifies an event timed relative to a program, such as a time or frame number for example, at which an action or script may be executed. Actions are collection of property modifications that may be performed together. Properties include the position, color and other attributes of a displayed object. Linkage may associate a file with an object such that a user may select a linked object to access websites, launch other applications, or to perform other tasks.

Parsing the enhancement file may produce an output file targeted to a specific platform or set of platforms. A platform may comprise a set top box, interactive television or computer display. A file parsed for computer display may be employed for emulation and preview of enhancements and may contain functions for control of a browser media player.

An enhancement file of XML format may be parsed using XSL (Extensible Stylesheet Language) scripts. In the present invention, an XML file with tags for administrative information, layout information, and trigger information is employed. The XML file may be parsed to produce an output file containing HTML and JavaScript code wherein the version of HTML and Javascript reflect the level of support provided by the target platform. Further, the output file may be formatted for a mode of enhancement transport. In a first mode of transport, enhancements and triggers are supplied in conjunction with a video program. In a second transport mode, triggers and a locator, such as a URL, for example, are provided in conjunction with a video program and the platform employs the locator to access enhancement information.

The invention may further comprise a system for developing television enhancements comprising a computer; a database; a web browser; and a parser operable to parse a platform independent enhancement file contained in the database and to produce an output that may be viewed employing the browser.

Advantageously, the invention provides viewing and emulation of enhancement files employing a personal computer or similar equipment. This allows a team of developers and reviewers to be physically separated, and allows enhancement customers (such as advertisers) to preview material by simply accessing a website.

### DESCRIPTION OF THE FIGURES

In the figures,

FIG. 1 depicts html and image support for a group of commercially available set top box products.

FIG. 2 depicts the environment of the present invention.

FIG. 3 depicts an environment in which the present invention may be utilized.

FIG. 4 depicts child element groups of a root element of an enhancement file of the present invention.

FIG. 5 depicts a content element and child elements that may be contained in the content element.

### DETAILED DESCRIPTION OF THE INVENTION

Enhanced television content comprises images, text, graphics and sounds that may be rendered in conjunction with a television program Enhanced television content is typically presented using a combination of HTML, JavaScript, Java and other web technologies. The level of support for these technologies varies by the targeted presentation platform, including the combination of client hardware, operating system, web browser and add-on software. A presentation platform may comprise a set top box, interactive television, computer, or other system operable to receive television signals and to process HTML and other code and to produce a display comprising a television image and enhancements. Capabilities vary depending the specific platform. Certain functions may or may not exist, or may be optimized on a given platform through the use of custom features. Variants include screen size and resolution, acceptable color combinations, graphics support, and version of HTML or JavaScript, for example. Providing concurrent support for the Internet or wireless handheld devices introduces additional requirements and dependencies. The present invention overcomes the difficulties of supporting multiple platforms, each having a specific set of capabilities, by employing a platform independent enhancement file that completely defines the enhancement assets, their location and other attributes, as well as the triggering information. The enhancement may be translated by parsing software to produce platform dependent files comprising HTML code and may contain JavaScript code tailored to the specific platform. The present invention also allows translation targeting a web browser and a media player, providing emulation and preview of authored enhancements.

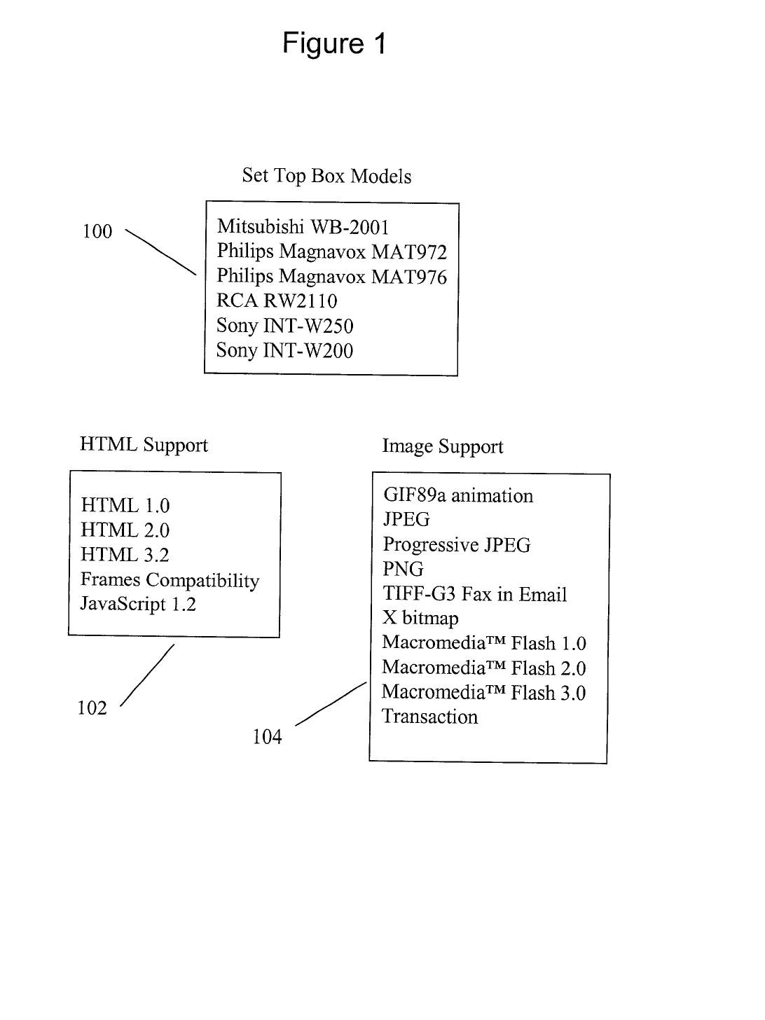

FIG. 1 depicts HTML and image support for a group of commercially available set top box products. Set top box models 100 provide HTML support 102 and image support 104. HTML support 102 lists support for html 1.0, 2.0, and 3.2 versions. A limitation of HTML is that some versions lack downward compatibility. For example, HTML versions 4 and higher do not support all the tags of HTML 3.2. FIG. 1 serves to illustrate that an HTML based author for creating enhanced content would not be able to support a wide range of target platforms.

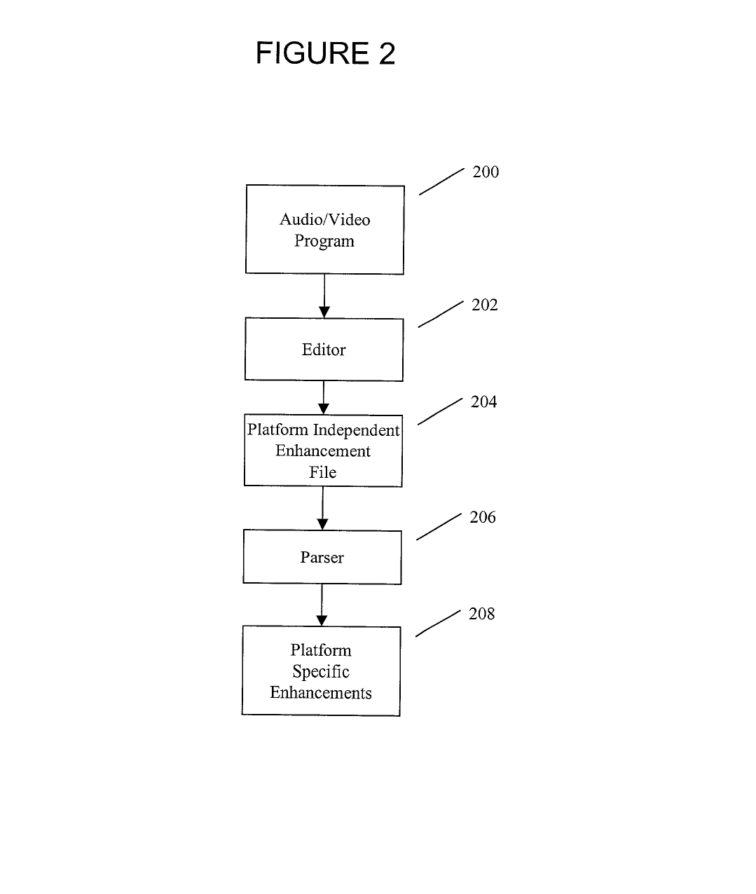

FIG. 2 illustrates the environment of the invention. Audio/video program 200 may be enhanced with editor 202. Editor 202 may allow selection, positioning, and scheduling of the rendering of displayable or audible elements. Scheduling may employ specific times in the audio/video program, such as frame numbers, for example. Further, editor 202 may be employed to define an action to be performed when a scheduled time occurs. Such action allows display and control of the display of elements. For example, an action may cause an element to be displayed, or to be displayed in a new position, or to be displayed with new attributes (such as color), or to no longer be displayed. Editor 202 may be similar to that disclosed in U.S. patent application No. 60/227,930 titled ‘System and Method for Web Based Enhanced Interactive Television Content Page Layout”. The result of editing is platform independent enhancement file 204. This file differs from HTML format files in that it contains scheduling and other control information. Parser 206 may be employed to parse platform independent enhancement file 204 to produce platform specific enhancements 208.

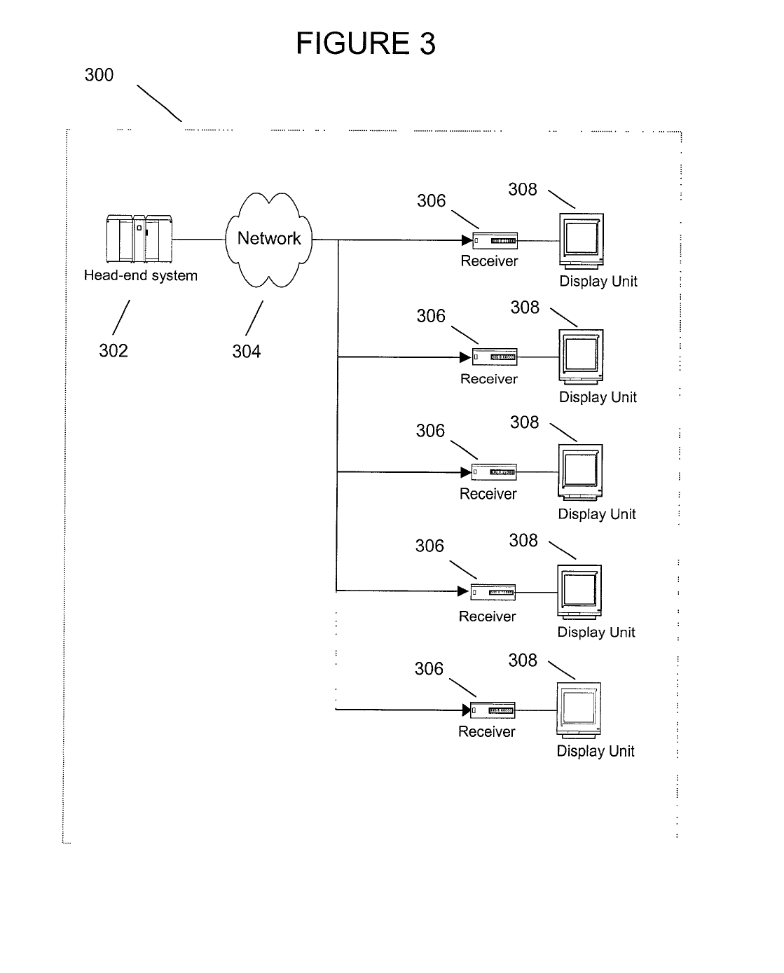

FIG. 3 depicts an environment in which the present invention may be utilized. Environment 300 comprises head-end system 302 that transfers data across network 304 to receivers 306 that provide signals to display units 308. Network 304 may comprise fiber optic, coaxial cable, terrestrial or satellite transmission, or combinations thereof, as is common to the art. Receivers 306 convert the incoming programming information into a format appropriate for input to display units 308, and thus for viewing by end users of the system. Receivers 306 may comprise set-top boxes, personal computers, interactive televisions, or other equipment operable to process television signals and other information, such as control information and program guides, for example. Display units 308 may comprise televisions, computer monitors, or other devices operable to display video images. One method of utilizing the present invention is to parse the platform independent enhancement file to produce an enhancement file compatible with receivers 306. Enhancement information may then be broadcast in conjunction with a program, or receivers may be configured to retrieve enhancement information employing an Internet connection or other network that is not depicted.

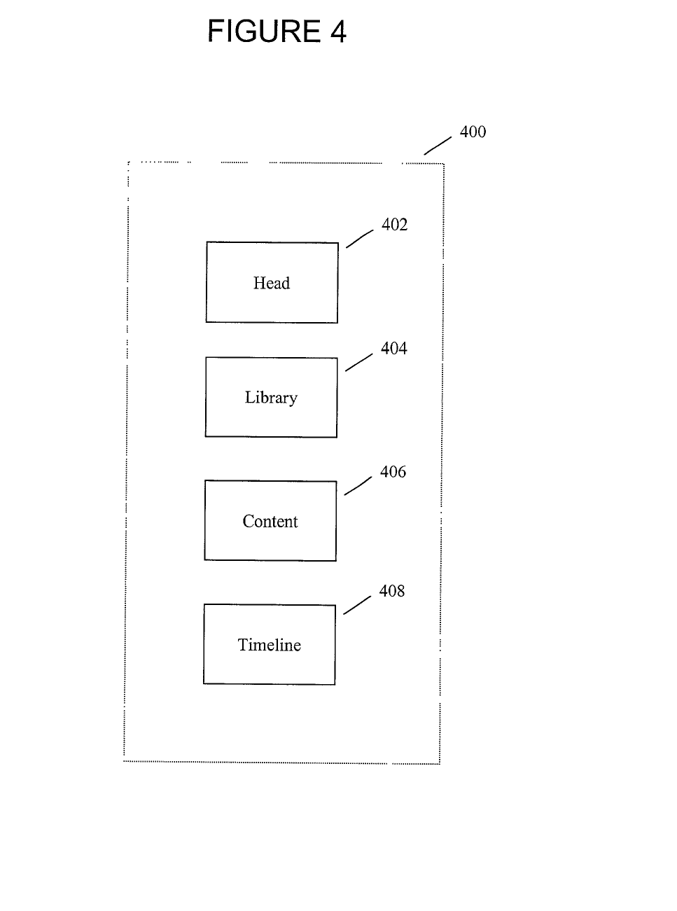

The present invention may comprise a file that includes enhancement types, enhancement attributes, scheduling, and other information. The file may be of XML format and may have a document structure with elements organized into groups of child elements. Attachment A provides a specification of an embodiment of the present invention. FIG. 4 depicts child element groups of a root element of an enhancement file of the present invention. Child elements 400 comprise head elements 402, library elements 404, content elements 406, and timeline elements 408. Head elements 402 may be employed to provide information such as document type, file name, library references, and other information such as author name and data created, for example. A meta element, similar to that of HTML, may be employed to describe a single piece of information describing the enhancement file. Library elements 404 may specify the location of object templates, storage location for a working file, and other locations for items such as tools and specifications, for example. Content elements 404 may be employed to define the type, attributes and content of displayable objects. Content elements are described in greater detail in a later section of this disclosure. Timeline elements 408 may be employed to specify and time schedule rendering of enhancements in conjunction with a program. Timeline elements are described in greater detail in a later section.

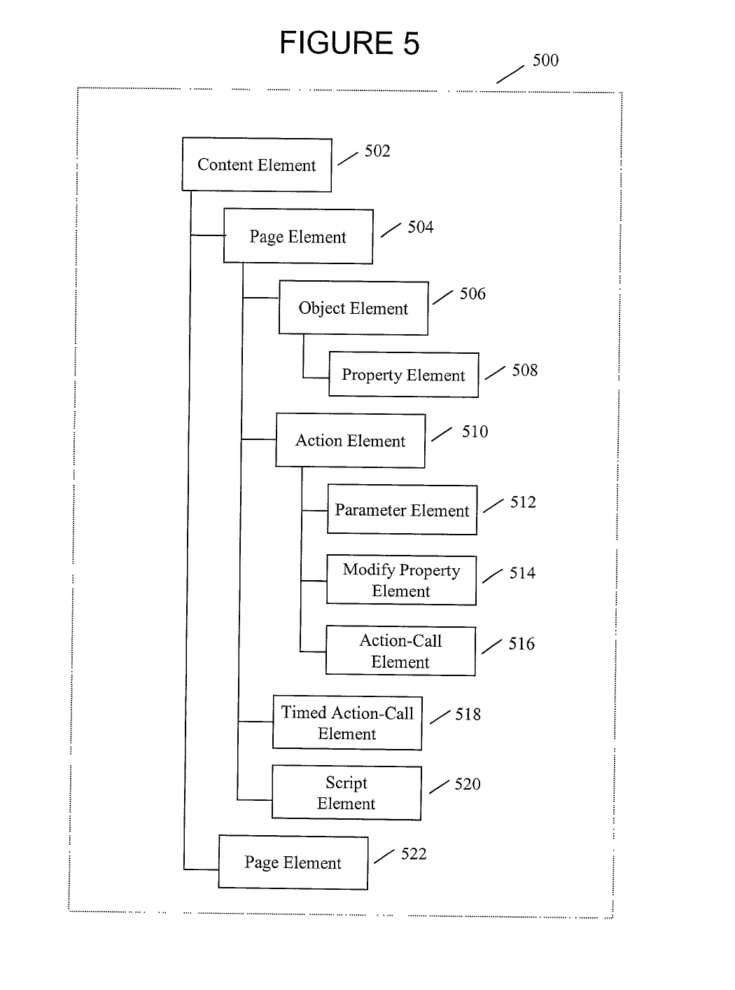

FIG. 5 depicts a content element and child elements that may be contained in the content element. Content element structure 500 comprises content element 502, page element 504, object element 506, property element 508, action element 510, parameter element 512, modify-property element 514, action-call element 516, timed action-call element 518, script element 520, and a second page element 522. Content element 502 describes general attributes of all contained pages. Attributes associated with content element 502 are described in Attachment A. A canvas attribute may describe the resolution in pixels of a single page of television content. A pixelAspect attribute may enable non-square pixels. A URL attribute may specify the location that a client-browser may use to access a page or pages. Page element 504 may contain a list of elements that define an object that may be displayed to the viewer, modifications to elements, timed-actions that specify when actions may occur, and may contain a script. Object element 506 specifies an object that may be rendered in conjunction with a program. Objects may comprise visual entities such as images, text and graphics. Objects may also comprise executable entities such as scripts. Other objects may be added within the scope of the present invention. Such objects may be employed to define or control additional program elements such as audio effects and sensory elements including motion and lighting, for example. Property element 508 defines an attribute of the object specified by object element 506. Attributes vary depending on object type and may include position, size, and color for example. A plurality of property elements may specify attributes for one object element. Attachment A defines property elements for object types such as image, text, field (that may be employed for user entry), tv (that may be employed to display a video program), and html. Action element 510 may list a set of modifications to element properties by specifying modify-property elements. For example, an action element may be employed to change the color of an object, or to change the z-order of the object such that it appears on top or behind another object if so positioned. An action may reference another action by including an action-call element. Parameter element 512 may be employed to specify a value passed to an action. The parameter can be used as a value in a property modification that is contained in the action. For example, a parameter element may specify a new text string to be displayed in an existing text object. When a timed-action-call or trigger refers to the action, the caller may specify a value for each parameter. Modify property element 514 may indicate a change to a property element by an action. A modify property element may indicate the object on the page that is to be modified. The name indicates the property of the element to affect. The value indicates the new property value. Action-call element 516 may indicate a call to another action by an action. A value attribute indicates the action to call. A reference to an action may be in the form of a function call with all parameters described in the definition of the action. Timed action-call element 518 is a call to an action or function in an included script that is timed relative to page invocation and not tied to the timeline of the broadcast video, as is a trigger element. Attributes for timed action-call element 518 are described in Attachment A. The attributes startTime, loopNTimes, and loopInterval may be employed to determine the starting point and frequency of the action specified by the value attribute. If loopNTimes is set to “0”, the action specified in the value may be repeated until the viewer navigates to another page. Timed action-call elements may be employed to produce effects such as blinking text, for example. The startTime and loopInterval values may be specified in seconds. Script element 520 may be employed to enable the use of a scripting language, such as javaScript, to perform calculations. The target attribute is a space-separated list of strings that filter the use of the script only to listed platforms. If target is not specified or specified as “any”, the script may be used on all platforms. The language attribute specifies the language of the script. The script can be included in the ITVML document by embedding the source code in the script element or the script may refer to an external file with the src attribute. A reference to an action may be in the form of a function call with any parameters described in the definition of the action.

An enhancement file produced using the scripting language of the present invention may be parsed employing an XSL parser to produce a platform dependent output file containing HTML and optionally containing javascript. XSL parsing information may be obtained from the following references.

Title: Professional XSL

Authors: Kurt Cagle et al.

Publisher: Wrox Press Inc;

ISBN: 1861003579

Title: XSL Companion, The

Author: Neil Bradley

Publisher: Addison-Wesley Pub Co;

ISBN: 0201674874

The foregoing description provides a platform independent enhancement that may be parsed to produce platform dependent files without needing to change the authored enhancements, saving time and money and providing a uniformity of enhancement across multiple platforms. The attached specification (Attachment A) employs a document definition to define both a language and a file format. The ‘element’ element of the attached specification has been described as an ‘object’ element in the foregoing description. An XML file format has been employed in the described embodiment. Other formats, both public and proprietary, may be employed to describe enhancements and attributes of the elements comprising enhancements. Enhancement output files allow enhancement of a television broadcast that may employ various methods of delivering enhancement data. A first method transfers enhancement data as part of the broadcast. A second method transfers a trigger and locator with the broadcast, and the set top box, or other platform, employs the locator to access enhancement information. The second method of transfer may further comprise receiving information identifying the type of platform requesting enhancement data (when the platform accesses the locator), and providing enhancement information suited to the requesting platform. A new or modified parser may be employed to support new platforms, or new versions of platforms. The new or modified parser then may be applied to a plurality of source enhancement files that need not be modified. In this manner, the present invention provides costs savings in supporting new platforms or new versions of platforms.

The foregoing description of the invention has been presented for purposes of illustration and description. It is not intended to be exhaustive or to limit the invention to the precise form disclosed, and other modifications and variations may be possible in light in the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A television enhancement programming language comprising:
an XML head element;
an object element that provides selection of an object;
a property element that specifies an attribute for said object; a modify-property element that modifies said attribute for said object;
a trigger element that specifies a time to render said object in relation to a video program; and
a television element that specifies a size and position at which said video program may be displayed.

2. The television enhancement programming language of claim 1 wherein said attribute specifies a URL associated with said object.

3. The television enhancement programming language of claim 1 further comprising:
an action element that provides a name for an action and contains at least one said modify-property element.

4. The television enhancement programming language of claim 1 further comprising:
an action-call element that allows a first action element to call a second action element.

5. The television enhancement programming language of claim 1 further comprising:
a script element that enables the use of a scripting language.

6. The television enhancement programming language of claim 1 further comprising:
a field element operable to accept user input.

7. The television enhancement programming language of claim 1 further comprising:
an attribute element that provides platform information for said object element.

8. The television enhancement programming language of claim 1 further comprising:
a timeline element that contains said trigger element and a payload element that defines data embedded in a program broadcast stream.

9. The television enhancement programming language of claim 8 further comprising:
a component element contained within said payload element.

10. The television enhancement programming language of claim 9 wherein said component element specifies a file address.

11. The television enhancement programming language of claim 9 wherein said component element specifies an expiration attribute.

12. The television enhancement programming language of claim 1 further comprising:
a page element that contains said object element and said attribute element.

13. The television enhancement programming language of claim 12 further comprising:
a timed action-call element that provides a call to an action that is not timed to display of a program.

14. A television enhancement file comprising:
an XML head element;
a television element that defines an area on a television screen where a television program may be displayed;
an object element;
a property element that describes at least one attribute of said object;
a modify-property element that modifies said attribute for said object;
a trigger element that specifies when said object may be rendered; and
a television element that specifies a size and position at which a program may be displayed.

15. The television enhancement file of claim 14 wherein said attribute specifies a URL associated with said object.

16. The television enhancement file of claim 14 further comprising:
an action element that provides a name for an action and contains at least one modify-property element.

17. The television enhancement file of claim 14 further comprising:
an action-call element that allows a first action element to call a second action element.

18. The television enhancement file of claim 14 further comprising:
a script element that enables the use of a scripting language.

19. The television enhancement file of claim 14 further comprising:
a field element operable to accept user input.

20. The television enhancement file of claim 14 further comprising:
a timeline element that contains said trigger element and a payload element that defines data embedded in a program broadcast stream.

21. The television enhancement file of claim 20 further comprising:
a component element contained within said payload element.

22. The television enhancement file of claim 21 wherein said component element specifies a file address.

23. The television enhancement file of claim 21 wherein said component element specifies an expiration attribute.

24. The television enhancement file of claim 14 further comprising:
a page element that contains said object element and said attribute element.

25. The television enhancement file of claim 24 further comprising:
a timed action-call element that provides a call to an action that is not timed to display of a program.

26. The television enhancement file of claim 14 wherein said property element specifies a z order value for at least one of said objects.

27. The television enhancement file of claim 14 further comprising:
an attribute element that provides platform information for said object element.

28. A system for developing television enhancements comprising:
a computer;
a database; and
an XML compliant television enhancement programming language operable to specify an object element that provides selection of an object, a property element that specifies an attribute for said object, a modify-property element operable to change the attribute for said object, a trigger element that specifies a time to render said object in relation to a program, and a television element that specifies a size and position at which a program may be displayed.
